(19) United States
(12) Patent Application Publication
(10) Pub. No.: US 2012/0278253 A1
(43) Pub. Date: Nov. 1, 2012

(54) DETERMINING SENTIMENT FOR COMMERCIAL ENTITIES

(76) Inventors: Himanshu GAHLOT, Emeryville, CA (US); William Krueger, San Francisco, CA (US); Dustin Preisler, San Francisco, CA (US); Adam Leary, San Francisco, CA (US)

(21) Appl. No.: 13/433,168

(22) Filed: Mar. 28, 2012

Related U.S. Application Data
(63) Continuation-in-part of application No. 13/098,302, filed on Apr. 29, 2011.

(51) Int. Cl. G06Q 30/00

(52) U.S. Cl. 705/347

(57) ABSTRACT

An overall sentiment is determined amongst a population of persons, for each of a plurality of commercial entities.

### RELATED APPLICATION(S)

This application is a continuation-in-part of Ser. No. 13/098,302, filed Apr. 29, 2011, which is hereby incorporated by reference in its entirety.

### TECHNICAL FIELD

Embodiments described herein pertain to sentiment determination, and more specifically, to a system and method for determining user sentiments for commercial entities, such as products and brands.

### BACKGROUND

There is much online content to describe products and brands. Increasingly, social media, such as provided through TWITTER or FACEBOOK, enable a medium where individuals can express appreciation of dislike for particular products or brands. At the same time, it is commonplace for many online sites to carry user generated product reviews expressing the user's thoughts on a particular product.

### BRIEF DESCRIPTION OF THE DRAWINGS

FIG. 1 illustrates a system for determining user sentiment for different types of entities, according to one or more embodiments.

FIG. 2 is a more detailed description of a system for determining user sentiment for different types of commercial entities, according to one or more embodiments.

FIG. 3 illustrates a method for providing product information that includes an overall sentiment relevant to the product, according to one or more embodiments.

FIG. 4 illustrates a method for providing sentiment-based output for products based on a sentiment that is determined for a relevant entity, according to an embodiment.

FIG. 5 illustrates an example of a presentation that can be generated as output from a system such as described by FIG. 2, under an embodiment.

FIG. 6 is a block diagram that illustrates a computer system upon which embodiments described herein may be implemented.

### DETAILED DESCRIPTION

Embodiments provide for determination of sentiment for commercial entities by persons. According to one or more embodiments, an overall sentiment is determined amongst a population of persons, for each of a plurality of commercial entities. Specific examples of commercial entities include products, brands, manufacturers or retailers, and/or product attributes. Other commercial entities include services, websites, or product nicknames.

In some embodiments, user generated communications provided through at least a first source are analyzed in order to determine a plurality of commercially-relevant statements made by a plurality of persons that comprise the population. Each of the plurality of commercially-relevant statements is determined to be relevant to one or more commercial entities of the plurality of commercial entities. For at least some of the commercially-relevant statements, a sentiment value is determined for each of the one or more corresponding commercial entities of the plurality of commercial entities. For each of the plurality of commercial entities, the overall sentiment is determined based on the sentiment value of each statement that is determined to be relevant to that commercial entity.

According to some embodiments, an output is provided that includes information about each of the plurality of commercial entities, the information including the overall sentiment determined for that commercial entity.

One or more embodiments include a sentiment engine that is configured to determine an overall sentiment, amongst a population of persons, for each of a plurality of commercial entities. In an embodiment, the sentiment engine executes a set of operations that includes analyzing user generated communications provided through at least a first source to determine a plurality of commercially-relevant statements made by a plurality of persons that comprise the population. Each of the plurality of commercially-relevant statements is determined to be relevant to one or more commercial entities of the plurality of commercial entities. The set of operations includes determining, for at least some of the commercially-relevant statements, a sentiment value for each of the one or more corresponding commercial entities of the plurality of commercial entities. The set of operations includes determining, for each of the plurality of commercial entities, the overall sentiment based on the sentiment value of each statement that is determined to be relevant to that commercial entity.

In some embodiments, system is provided for determining sentiment for commercial entities by persons. The system includes a memory that stores a set of instructions, and one or more processors that access the instructions to provide a sentiment engine and an output component. The output component provides a presentation that includes information about each of the plurality of commercial entities. The information includes the overall sentiment determined for that commercial entity.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried out and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and tablets), and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Overview

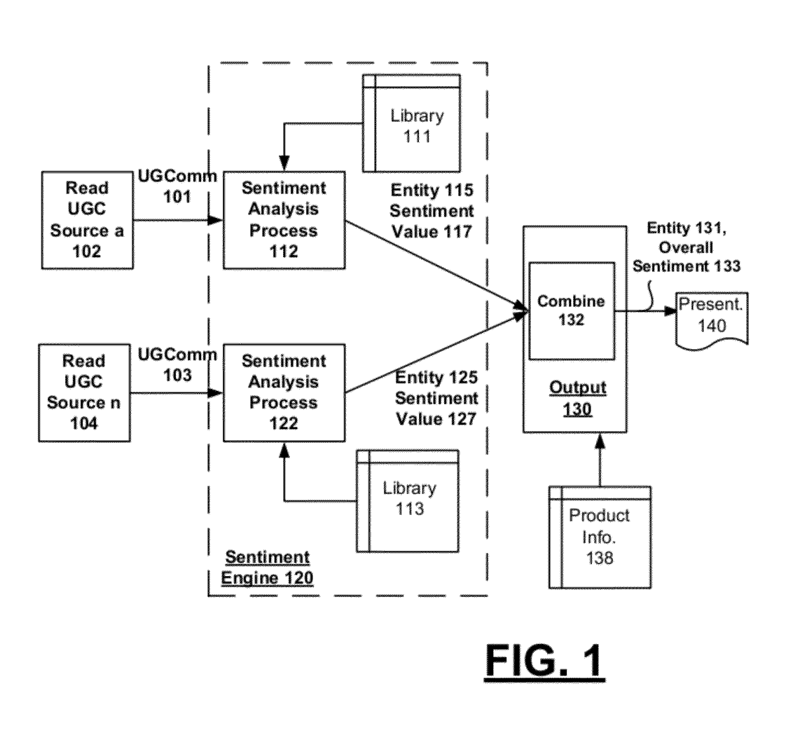

FIG. 1 illustrates a system for determining user sentiment for different types of entities, according to one or more embodiments. A system 100 such as described may be implemented in a variety of computing environments. In some embodiments, system 100 is implemented as a service, provided through a server or combination of servers, for determining sentiment data that is indicative of user sentiment amongst a population of people for a particular commercial entity. In variations, some or all of the functionality described with system 100 may be implemented in alternative computing environments, such as on user or client machines.

In an embodiment, system 100 includes components 102, 104 for reading user generated communications from different sources, a sentiment analysis engine 120, and an output component 130. Examples of sources for user generated communications include social networking sites (e.g., such as provided by TWITTER or FACEBOOK), product review sites (e.g., such as provided by CNET or AMAZON), messaging forums, or web-pages that carry commentary from users. In an example such as provided, the user generated communications can include social media, such as microblogs (e.g., TWEETS made through TWITTER), social network postings, and user commentary, including product reviews by consumers (or users).

In an embodiment, components 102, 104 scrape content from specific sites that have user generated communications. In variations, one or more of components 102, 104 interface or communicate with programmatic interfaces of sites that provide user generated communications, in order to receive feeds of user communications or other forms of user generated communications from those sites.

According to embodiments, the user generated communications are in the form of statements or phrases, such as provided by prose or chat-style statements. Accordingly, the user generated communications can be relatively unstructured, and typically unprompted. For example, the sources for the user generated communications may provide little or no structure as to what the individual persons will include in their communications. As such, the user generated communications are distinct from, for example, ratings, which can be prompted quantitative assessments from users, or survey input obtained from users who select answers from a pre-determined list of answers.

As output, components 102, 104 stream or otherwise provide user generated communications 101, 103, such as posts, messages (e.g., microblogs) or product reviews, to the sentiment analysis engine 120. The sentiment analysis engine 120 can implement one or more sentiment analyses processes 112, 122. In an embodiment, the sentiment analysis engine 120 implements a separate sentiment analysis processes 112, 122 for each source of user generated communications. In particular, each sentiment analysis process 112, 122 may incorporate a corresponding library 111, 113 of terms and configurations. Each library 111, 113 can be trained or otherwise developed for the corresponding sources of user generated communications. Thus, the sentiment analysis process 112, implemented for a particular source of user generated communications (e.g., social media source such as TWITTER), can differ from the sentiment analysis process 122 implemented for a different source of user generated communications (e.g., a different social media source such as FACEBOOK, or a product review site).

In embodiments, the sentiment analysis processes 112, 122 each operate to identify sentiment expressed by individual users for a particular commercial entity or set of commercial entities. Different types of commercial entities may be identified from the various user generated communications. Specific examples of commercial entities include products, brands, and/or product attributes (e.g., display size or type).

Moreover, some embodiments provide for identifying different types of commercial entities from different sources of user generated communications. For example, in one embodiment, sentiment analysis process 112 can be implemented for social network media to obtain sentiment for brands, while sentiment analysis process 122 is implemented for a product review site in order to determine sentiment for products and/or product attributes. The selection of what commercial entities are to be identified from each source of user generated communications can depend on the nature of the particular source. For example, embodiments recognize that social network media, including microblogs sites (e.g., TWITTER) provide more relevant information for brands, while product review sites are specific to products and/or product attributes.

Accordingly, an embodiment provides that the sentiment analysis process 112 receives user generated communications 101 to determine (i) a list of entities 115 identified from the communications of the first source of user generated communications, and (ii) a sentiment value 117 indicative of sentiment expressed by individual communications for each of the respective entities 115. Similarly, additional sentiment analysis process(es) 122 determine (i) entities 125 and (ii) a sentiment value 127 indicative of sentiment expressed by individual communications of the second (or additional) sources for the respective individual entities 125. In some embodiments, different types of commercial entities are determined for the different sources of user generated communications. For example, as provided in a previous example, the first sentiment analysis process 112 can be implemented on social media feeds in order to determine sentiment values 117 for commercial entities 115 corresponding to brands, and the second sentiment analysis process 122 can be implemented on user product reviews in order to determine sentiment values 127 for commercial entities 125 corresponding to products. The sentiment analysis processes 112, 122 can also identify terms of emphatics or negation in order to increase, decrease or reverse the pre-determined sentiment value associated with a particular term.

The output component 130 generates one or more presentations 140 that display an overall sentiment determination 133 for individual commercial entities 131. In an embodiment, the output component 130 includes a process 132 to combine the sentiment values 117, 127 as determined from the different user generated communications. The combining process 132 can include separate operations to tally, sum or average sentiment values for specific commercial entities. In addition, the combining process 132 can correlate commercial entities to one another. For example, a brand can be correlated to a set of products or vice-versa.

In one embodiment, the presentation 140 displays overall sentiment determination 133 for an entity 131 (e.g., a product and/or a brand) in connection with product information 138 that includes technical specification, manufacturer description, expert (non-user) product reviews and/or product reviews. For example, a product page or document may include (i) product information 138, and (ii) an overall sentiment determination 133 for the product or brand, as determined from the sentiment analysis engine 120.

According to embodiments, the overall sentiment determination 133 can be expressed quantitatively, and range between values indicating overall like or dislike. The overall sentiment determination 133 can be based on individual sentiment values 117, 127 that are determined for the same entity. For example, the overall sentiment determination can be a tally, summation, or average (e.g., weighted or otherwise) of individual sentiment values that are determined to exist for communications that mention specific entities.

In one embodiment, the sentiment values 117, 127 determined from the respective sentiment determination processes 112, 122 are binary values, indicating an expression of like or dislike for a particular entity in a statement from a user. In a variation, the sentiment values 117, 127 are trinary, corresponding to like, dislike or neutral. The spectrum of possible sentiment values 117, 127, as well as the overall sentiment determination 133 can be varied based on implementation of embodiments such as described.

The overall sentiment determination 133 can range in value, similar to sentiment values for individual terms, so as to range between sentiments of like and dislike. Thus, the tallying, summation or average of sentiment values can produce a range that coincides with the sentiment determined for the particular product amongst a population of users. Furthermore, as described below, the overall sentiment can comprise sentiment values for terms that are affected positively or negatively by terms/characters of emphatics or negations.

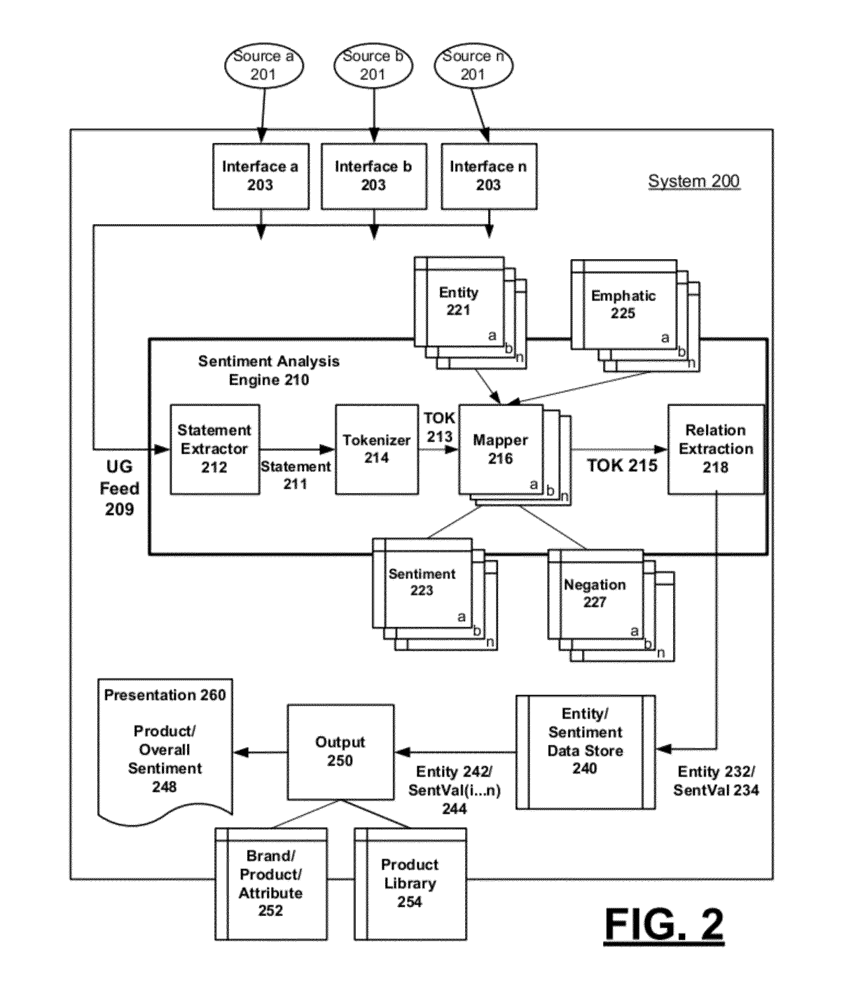

FIG. 2 is a more detailed description of a system for determining user sentiment for different types of commercial entities, according to one or more embodiments. A system 200 can be implemented as an example of a system such as described with FIG. 1. Accordingly, system 200 can be provided as a service, provided through a server or combination of servers, for determining sentiment data that is indicative of user sentiment amongst a population of people for a particular commercial entity. In variations, some or all of the functionality described with system 200 may be implemented in alternative computing environments, such as on user or client machines.

In an embodiment, system 200 includes one or more interfaces 203 (a, b, . . . n) to sources of user generated communications 201(a, b, . . . n), sentiment analysis engine 210, and entity data store 240, and an output component 250. Each of the one or more interfaces 203 can be structured or otherwise configured to a corresponding one of the sources 201. As an example, one or more of the interfaces 203 can include a web crawler and text scraper that is configured to access a particular site or services (e.g., social networking sites) in order to scrape user generated comments. In other variations, one or more of the interfaces 203 can include programmatic interfaces that receive feeds that include user generated communications from other sites. Numerous other variations are possible as to how the interfaces 203 can be implemented. Each interface 203 can be configured and is structured for its corresponding source 201 for user generated communications.

The sentiment analysis engine 210 can implement different sentiment analysis processes using a combination of components. In an embodiment, components of sentiment analysis engine 210 include a statement extractor 212, a tokenizer 214, a mapper 216, and a relation extraction 218. The interfaces 203 operate to provide the sentiment analysis engine 210 with user generated communication input 209. The statement extractor 212 extracts commercially relevant statements 211 from individual communications provided as part of the user generated communication input 209. The tokenizer 214 parses the individual statements 211 to identify tokens 213, corresponding to words or phrases.

The mapper 216 determines whether individual tokens 213 from the particular communication correspond to an entity or a sentiment. Additionally, an embodiment provides that the mapper 216 identifies whether individual tokens 213 include characters, terms or phrases that are of a class of emphatics or negations. In an embodiment, mapper 216 uses a set of dictionaries in order to determine characters, words, or phrases that are relevant to determining expressions of sentiment for commercial entities. In particular, an embodiment provides that the mapper 216 utilizes (i) an entity dictionary 221 to identify expressions for a particular commercial entity (e.g., brand, product or product attribute), (ii) a sentiment dictionary 223 to identify expressions that are indicative of an emotion or attitude, as well as a value for the particular sentiment expression, (iii) an emphatic dictionary 225 that can include characters (e.g., “!”) terms or phrases of emphasis, and (iv) a negation dictionary 227 which can indicate an opposite to an expression of emotion or attitude carried by a sentiment term. In an embodiment, the sentiment value carried by a sentiment term can be provided as a numeric range that extends between a positive value and a negative value. In some embodiments, each sentiment term can have a binary value corresponding to positive or negative, or alternatively a trinary value for positive, negative, or neutral. Terms or characters for emphatics may increase the value assigned to the sentiment term when present.

According to some embodiments, one or more of the dictionaries may be based on, or otherwise tailored for a particular domain, and more specifically, for a particular source. For example, the entity dictionary 221 may comprise a list of brands for when the source of the user generated communication input 209 is a social network feed. Likewise, the entity dictionary 221 may comprise a list of products and/or product descriptions when the source of the user generated communication input 209 is a product review site. Other dictionaries used by the mapper 216 may be similarly tailored for the particular source of input. For example, sentiment dictionary 223 can include abbreviations, slang or acronymal expressions of positive and negative sentiment based on the source of user generated communication input 209 being a social network feed where such expressions are prevalent (e.g., “luv” “wow”, etc.). Thus, mapper 216 may implement different sets of dictionaries for each of the sources 201 (a, b, . . . n) for user generated communications. The mapper 216 uses the sets of dictionaries in order to identify a set of relevant tokens 215 (characters, words, phrases) for sentiment (emotion or attitude), commercial entity, emphasis and/or negation.

As an alternative to using one or more of the dictionaries, some embodiments can utilize machine learning algorithms to train sentiment analysis engine 210 into learning about entities and sentiment, as well emphatics or negation. A training set of terms may be utilized as part of the training. Various forms of existing machine learning techniques may be employed, including Support Vector Machine (SVM), Conditional Random Fields (CRF), Maximum Entropy, Naïve Bayes and/or variants thereof. Sequential learning algorithms, such as CRF, are particularly effective for identifying named entities.

The relation extraction 218 uses the relevant set of tokens 215 to determine (i) whether the particular communication can be deemed to express a sentiment for a particular commercial entity, and (ii) value the expressed sentiment if one is deemed present. In an embodiment, the relation extraction 218 determines whether the relevant set of tokens 215 in an individual user generated communication expresses a positive or negative sentiment about a particular commercial entity. In order to determine whether sentiment is expressed for a commercial entity, the relation extraction 218 may operate to first determine whether an expression of sentiment in a statement relates to a commercial entity. For example, while the presence of an entity term and a sentiment term in the same sentence are indicative that the sentiment term relates to the entity term, the determination may not be conclusive based on this fact alone. Likewise, while the presence of an entity term in a separate sentence from a sentiment term is indicative that the two terms are not relevant to one another, the same conclusion may not necessarily be doubt based on that fact alone.

Accordingly, relation extraction 218 implements a set of logic, including rules and algorithms, to determine whether a term of sentiment expressed in a user generated communication is for a commercial entity that is also present in the same communication. The following provide examples of logic that can be implemented in order to determine the relation of the sentiment term to the entity term.

A logic may identify subject, verb and predicate from a sentence. The logic may further determine whether the subject of a sentence is a commercial entity by comparing the noun that is suspect as the subject to a list of entities for the particular domain. The logic may further determine whether sentiment expression is in the sentence's predicate, and if both conditions are true (i.e., the subject is a commercial entity and the predicate includes the sentiment term), then the sentiment term applies to the identified entity of the subject.

Furthermore, if the subject or predicate are complex, the logic can apply rules to identify the subject or predicate. For example, a rule may provide for the subject to be identified as a first noun in the clause.

Some sentences/clauses can be identified as modal with presence of words that are conditional (e.g., “if”, “would”, “might have been”). Such clauses typically reflect sentiment to a noun of the clause. Other clauses that can be identified from content include dependent clauses, which include specific expressions that signify the presence of a dependent clause. The presence of sentiment terms in such clauses also can carry direct relevance to the noun expressed in the clause.

As an addition or alternative rule, word proximity may be used to determine whether a sentiment term relates to an entity term. In one embodiment, if a given statement is analyzed to determine that the sentiment term is present, then the sentiment term is associated with an entity if the entity term appears within a set number of words or characters from the sentiment term (e.g., sentiment term is within word range of five from entity term).

Likewise, rules may be applied to determine when tokens 215 of negation or emphatics relate to a sentiment term. As an example of negation, the presence of “not”, “no” or “never” near the sentiment words (e.g., “not good”, “never found entertaining”, etc.) may reverse the polarity of the value otherwise carried by the sentiment term. As an example of emphatics, the presence of “!” in a sentence that carries sentiment and entity may increase the sentiment value of the sentiment term.

Each sentiment term that is identified from a given communication may be associated with a sentiment value. In embodiments, the sentiment value is either positive or negative (binary), or positive, negative or neutral (trinary). In variations, the predetermined sentiment value for a term includes a range that represents an intensity of sentiment. For example, the sentiment value for the term “fantastic” may be greater than the sentiment value for the term “good.” As described below, the sentiment values for the individual terms can be adjusted from the predetermined sentiment value based on other factors, such as the presence of emphatic or negation terms/characters.

For each analyzed user generated communication, an output of the sentiment analysis engine 210 includes a commercial entity 232 and a corresponding sentiment value 234. The sentiment value 234 may reflect a positive, negative or neutral value associated with the particular sentiment term. In some embodiments, the sentiment value 234 for the particular term can be increased or weighted based on the presence of emphatic characters or terms. Additionally, the sentiment value 234 can reverse or negate the sentiment value that is pre-associated with the particular term based on the presence of negation terms in an analyzed statement.

The data store 240 represents a structured data source where data for each commercial entity 232 and its corresponding sentiment value 234 is aggregated. For example, numerous user generated communications can be analyzed for their respective mentioning of an entity (e.g., brand, product), and the sentiment identified in some of the communications may be correlated to a sentiment value. The data store 240 can list the sentiment values identified from each mentioning of the particular entity. As an alternative or variation, the data store 240 can associate the summation/average of all of the sentiment values identified for the particular entity in a structured form.

An output component 250 can access the data store 240 to determine entities 242 and corresponding sentiment values 244. The output component 250 determines an overall sentiment 248 for each entity 242. The overall sentiment 248 can be based on, for example, a summation or average of the sentiment values 244 identified for each entity 242. Alternatively, the overall sentiment 248 can be based on a tally of the sentiment values which are positive/negative or positive/neutral/negative. For example, the tally can count the number of positive and negative sentiment expressions provided for a particular entity. The overall sentiment 248 can be a numeric or quantitative expression ranging between values for like and dislike.

As an addition or alternative, the output component 250 can correlate some entities with one another in order to determine the overall sentiment for a particular entity. A correlation data store 252 may correlate entities to one another. For example, brands may correlate to products, products may correlate to other products, or products may correlate to product attributes. The correlation data store 252 may use correlations for further determination of the overall sentiments for specific entities. For example, a brand entity can be correlated to one or more product entities, and the overall sentiment of the individual product entities may be based at least in part on an overall sentiment of the brand. As an addition or variation, the overall sentiment 248 for a particular product can be based in part on the sentiment values of a particular product attribute (e.g., display screen). As still another addition or variation, the overall sentiment 248 for a particular product can be based in part on the sentiment values of other products of a particular class or attribute. Numerous other such variations are possible.

In addition, the output component 250 can utilize a product library 254 to obtain additional non-sentiment information about brands, products and product attributes. The information includes technical specification, manufacturer description, expert (non-user) product reviews and/or product reviews. The output component 250 can generate a presentation 260 that includes the overall sentiment for specific entities, along with other information such as provided from the product library 254. Examples of the presentation 260 include (i) a product review document that includes one or more product reviews (expert or user) with a graphic representation of the overall sentiment 248 for that product, product brand and/or product attribute, (ii) a product review document including graphic representation of the overall sentiment 248 for a product in place of product reviews (e.g., first review for a product), and/or (iii) a manufacturer or brand document that lists products and overall sentiment for the brand or the products of the brand. An example of presentation 260 is provided with FIG. 5.

Methodology

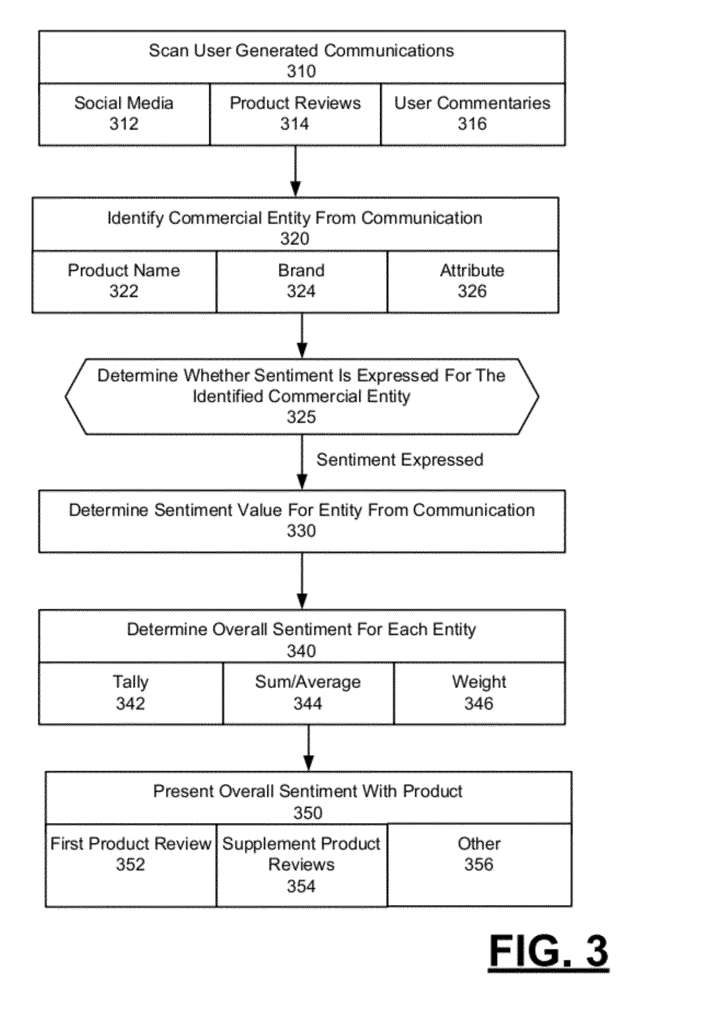

FIG. 3 illustrates a method for providing product information that includes an overall sentiment relevant to the product, according to one or more embodiments. A method such as described with FIG. 3 may be implemented using, for example, a system such as described with FIG. 2. Accordingly, reference may be made to elements of FIG. 2 for purpose of illustrating a suitable component or element for performing a step or sub-step being described.

In an embodiment, user generated communications are scanned (310) for commercially relevant statements that include expressions of sentiment. The user generated communications can include, for example, a social network media (e.g., microblog entry, post, “check-in”, etc.) (312), user reviews on product sites (314), commentary on web pages (316), and message board forums. The form for the communication comprises unstructured and unprompted statements, generally including sentence structures or clauses that include subject, verb and predicate. Embodiments recognize, however, that some social media can be slang or communicated through minimum number of words that do not collectively amount to a sentence.

A commercial entity is determined from the communication (320). Examples of the commercial entities include a product name (322), a brand (324), or a product attribute (326).

For the commercially relevant statements, a determination is made as to whether a sentiment is expressed for the identified commercial entity (325). If sentiment is expressed, the value of the sentiment is determined (330). The sentiment term can be associated with a predetermined sentiment value (e.g., positive, negative or neutral). The sentiment value can also be determined by presence of a negation term or character, which can reverse or negate the inherent value of the sentiment term. As an addition or alternative, the presence of the emphatic term or character can increase or decrease the inherent value of the sentiment term.

The overall sentiment for the commercial entity (340) can be determined based on the sentiment value for sentiment terms that appear with the entity in user generated communications. The overall sentiment value can be determined by, for example, tallying (e.g., graphically) (342), summing/averaging (344) or weighting the average (346) of the sentiment values for each instance in which the particular entity is mentioned with sentiment in a user generated communication.

The overall sentiment is presented in connection with a relevant product (350). For example, the overall sentiment can be presented with product information for purpose of providing a “cold start” product review (e.g., when no user has provided a product review for a new product) (352). A particular product can be provided with the overall sentiment for the product, for the product's brand (e.g., manufacturer's brand) or for the product attribute. Alternatively, the overall sentiment for the product (or the product brand or product attribute) can be provided to supplement product reviews or other product information (354). Other presentations specific to product, product brand or product attribute can also be generated using a relevant overall sentiment (356).

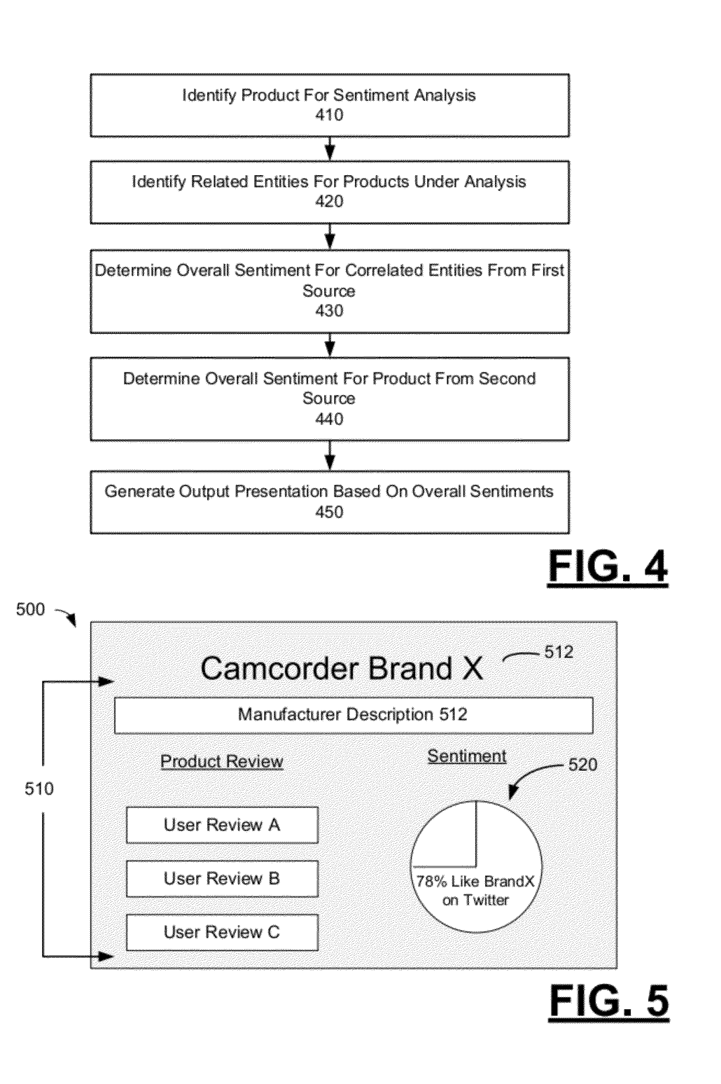

FIG. 4 illustrates a method for providing sentiment-based output for products based on a sentiment that is determined for a relevant entity, according to an embodiment. A method such as described with FIG. 4 may be implemented using, for example, a system such as described with FIG. 2. Accordingly, reference may be made to elements of FIG. 2 for the purpose of illustrating a suitable component or element for performing a step or sub-step being described.

In an embodiment, a product is identified for sentiment analysis (410). For example, an online library of content items can be scanned for purpose of determining a relevant identifier for the individual products. The content item for each of the products can include tags, text or images, each of which can be analyzed to determine an identifier for the particular product (e.g., product name). With reference to an embodiment of FIG. 2, for example, output component 250 can identify products from product library 254 using identifiers such as product name, manufacturer name, or serial number.

For individual products that are being analyzed, one or more related entities are identified (420). The related entities can include a brand, a related product, or a product attribute. For example, content items for individual products that are identified in an online product library can be programmatically reviewed in order to identify the brand associated with the particular product. The correlation can be made through use of data items included with the individual content items, or alternatively, through a correlation data store which can include data that links individual products to other entities. For example, tags associated with content items that are pre-existing for products can be scanned for brand name. Alternatively, a brand/product list (e.g., provided by data store 252 of FIG. 2) may be maintained to identify terms that are brands. If the brand for the identified product is not readily determined from tags or the content item for the product, then the brand/product list can be used to correlate the product identifier to the brand.

In variations, other correlations may be made between product identifiers and entities. In particular, correlations can be made between a product identifier and other products that carry an important attribute of the product. For example, the content item for a computing device can be scanned for tags that indicate the computing device's operating system, and the correlation may include identifying products that have the same operating system or platform.

The overall sentiment for correlated entities is then determined from at least a first source of user generated communications (430). The source may be selected for the correlated entity. For example, social media may be known to carry more communications about brand than specific products, while product review sites may be known to carry information about comparable products or product attributes. The overall sentiment for each correlated entity can reflect a tallying, summation, average or other expression that is based on sentiment scores identified for individual communications that make mention of the particular correlated entity.

The overall sentiment for the product can also be determined (440). In an embodiment, the overall sentiment for the product can be determined from a second source for user generated communications (e.g., product review site). In variations, multiple sources are used for different types of related entities (if more than one related entity is used), as well as the particular product under analysis. The sentiment score can reflect a tallying, summation, average or other expression that is based on sentiment scores identified for individual communications that make mention of the particular product.

An output presentation is then generated based on the overall sentiment of the product and its correlated entity (450). The output presentation can display sentiment information for the product in a variety of formats or context. For example, the overall sentiment(s) can be expressed quantitatively, such as through a number that indicates the number or percentage of persons who liked the product (or brand, or product attribute) versus those who did not. In such representations, the overall sentiments can also be expressed graphically, such as through charts or other images which indicate the extent that the product, brand or product attribute is liked or disliked amongst a population of users.

In the context of a content item where the described product is relatively new to market and has no user reviews, an overall sentiment for the product, product's brand or for the product's attribute (e.g., display or operating system) may be utilized to enable a cold start review. Additionally, the qualitative description of the overall sentiment (e.g., “this product is very liked by users on TWITTER.”) can be used in place of user reviews.

### ALTERNATIVES AND EXAMPLES

FIG. 5 illustrates an example of a presentation that can be generated as output from a system such as described by FIG. 2, under an embodiment. A presentation 500 can include a content item (e.g., document with image) that includes product information 510, including, for example, a product identifier 508, manufacturer description 512 (e.g., manufacturer summary or technical information) and user reviews 514 of the product.

The product information can be supplemented by sentiment information 520. The sentiment information 520 can take various forms. In an embodiment such as shown, the sentiment information 520 is for the brand of the product. In variations, other correlated entities can be used for the purpose of determining relevant sentiment information. Still further, the sentiment information 520 can be specific for the product rather than brand or other correlated entity.

The format for the sentiment information 520 can be design or implementation specific. In one embodiment, the overall sentiment for the brand (or for product, product attribute, similar products, etc.) is presented graphically and indicates a number of persons in a population who like the particular entity. In variations, the overall sentiment can be displayed as, for example, a score that indicates (i) number or percentage of persons who like or dislike the particular entity, and/or (ii) the extent to which the particular entity is liked or disliked (e.g., “very liked” versus “somewhat liked”).

In some embodiments, the corporate entity that is identified from one or more sources of user generated communications corresponds to a product attribute, such as an operating system, a device accessory, a display type, etc. In such embodiments, the results of the sentiment analysis can include displaying an overall sentiment for a particular product attribute, which can be shared by multiple products. For example, a content item can be generated which displays the overall sentiment for an operating system, independent of computing devices that utilize the operating system.

Still further, the output provided by, for example, output component 250 generates presentations that are based on topics, rather than products. Topics can be specific to a product attribute, or to a generalization of a product attribute. For example, several entities (e.g., product attributes) can be combined into a topic. As a more specific example, a topic termed “tactile controls” can be generated for product attributes that include “mouse,” “navigation,” “touchpad” or “left/right click.” The overall sentiment for the generated topic can be provided by, for example, summing or averaging the overall sentiments that are recorded for each of the attributes that are components of the topic. Still further, separate sentiment information items can be presented for each component of the topic. The determination of topics relating to product attributes or other entities can be performed programmatically, using algorithmic modeling or learning techniques such as Latent Dirichlet allocation (LDA).

Computer System

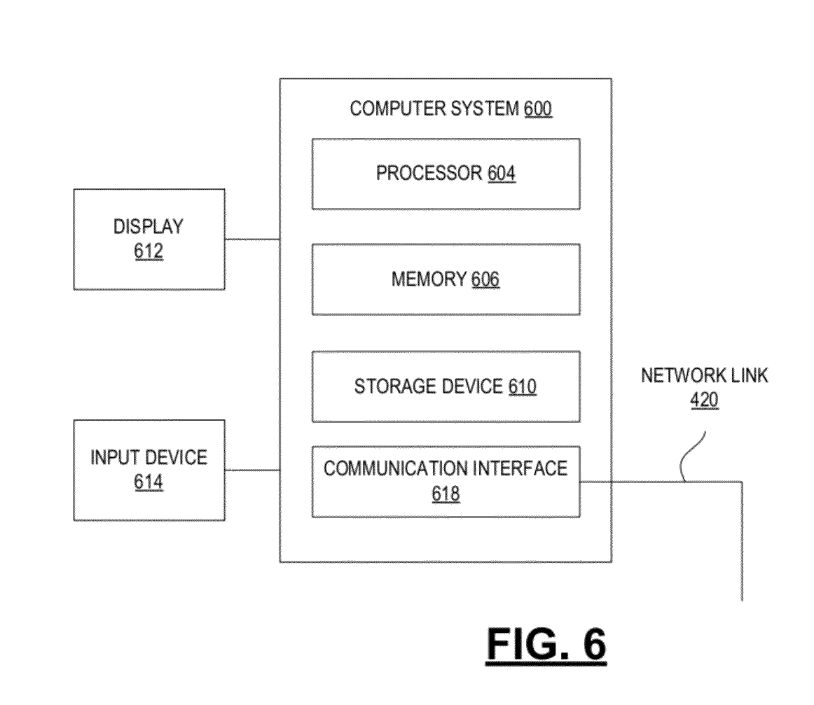

FIG. 6 is a block diagram that illustrates a computer system upon which embodiments described herein may be implemented. For example, in the context of FIG. 1, system 100 may be implemented using a computer system such as described by FIG. 6.

In an embodiment, computer system 600 includes processor 604, memory 606 (including non-transitory memory), storage device 610, and communication interface 618. Computer system 600 includes at least one processor 604 for processing information. Computer system 600 also includes a main memory 606, such as a random access memory (RAM) or other dynamic storage device, for storing information and instructions to be executed by processor 604. Main memory 606 also may be used for storing temporary variables or other intermediate information during execution of instructions to be executed by processor 604. Computer system 600 may also include a read only memory (ROM) or other static storage device for storing static information and instructions for processor 604. A storage device 610, such as a magnetic disk or optical disk, is provided for storing information and instructions. The communication interface 618 may enable the computer system 600 to communicate with one or more networks through use of the network link 620 (wireless or wireline).

Computer system 600 can include display 612, such as a cathode ray tube (CRT), a LCD monitor, and a television set, for displaying information to a user. An input device 614, including alphanumeric and other keys, is coupled to computer system 600 for communicating information and command selections to processor 604. Other non-limiting, illustrative examples of input device 614 include a mouse, a trackball, or cursor direction keys for communicating direction information and command selections to processor 604 and for controlling cursor movement on display 612. While only one input device 614 is depicted in FIG. 6, embodiments may include any number of input devices 614 coupled to computer system 600.

Embodiments described herein are related to the use of computer system 600 for implementing the techniques described herein. According to one embodiment, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for determining sentiment for commercial entities by persons, the method being implemented by one or more processors and comprising:
determining an overall sentiment, amongst a population of persons, for each of a plurality of commercial entities, wherein determining the overall sentiment includes:
analyzing user generated communications provided through at least a first source to determine a plurality of commercially-relevant statements made by a plurality of persons that comprise the population, each of the plurality of commercially-relevant statements being determined to be relevant to one or more commercial entities of the plurality of commercial entities;
for at least some of the plurality of commercially-relevant statements, determining a sentiment value for each of the one or more corresponding commercial entities of the plurality of commercial entities;
for each of the plurality of commercial entities, determining the overall sentiment based on the sentiment value of each statement that is determined to be relevant to that commercial entity; and
providing an output that includes information about each of the plurality of commercial entities, the information including the overall sentiment determined for that commercial entity.

2. The method of claim 1, wherein the commercial entity includes a brand.

3. The method of claim 1, wherein the commercial entity includes a product.

4. The method of claim 1, wherein the commercial entity includes a product attribute.

5. The method of claim 1, wherein analyzing user generated communications includes analyzing comments made through a social network resource.

6. The method of claim 1, wherein analyzing user generated communications includes analyzing a plurality of micro-blogging entries made by a population of persons.

7. The method of claim 1, wherein the sentiment value is trinary and includes values for positive, neutral and negative.

8. The method of claim 1, wherein the sentiment value is binary and includes values for positive and negative.

9. The method of claim 1, wherein the overall sentiment of each commercial entity includes a summation of each sentiment value that is determined for that commercial entity.

10. The method of claim 1, wherein determining the overall sentiment includes determining a brand sentiment value for a brand related to a given product, and correlating the brand sentiment value to the given product.

11. The method of claim 1, wherein determining the overall sentiment includes analyzing user generated communications through at least the first source and a second source.

12. The method of claim 11, wherein the first source is a social network resource and the second source is a user product review resource.

13. The method of claim 12, wherein determining the overall sentiment includes determining the sentiment of a given product by:
determining, from the first source, a brand sentiment value for a brand related to the given product,
determining, from the second source, a product sentiment value for the given product, and
wherein the overall sentiment for the given product is based on the brand sentiment value and the product sentiment value.

14. The method of claim 11, wherein at least one of (i) analyzing user generated communications or (ii) determining the sentiment value is configured specifically for each of the first source and second source.

15. A system for determining sentiment for commercial entities by persons, the system comprising:
a memory that stores a set of instructions;
one or more processors that access the instructions to provide:
a sentiment engine to determine an overall sentiment, amongst a population of persons, for each of a plurality of commercial entities;
an output component that provides a presentation that includes information about each of the plurality of commercial entities, the information including the overall sentiment determined for that commercial entity.

16. The system of claim 15, wherein the sentiment engine uses a set of character-term dictionaries in determining the overall sentiment for each of the plurality of commercial entities.

17. The system of claim 16, wherein the sentiment engine determines the overall sentiment for each of the plurality of commercial entities using multiple sources of user generated communications, including user generated communications from one or more sources that are social networking mediums.

18. The system of claim 17, wherein the sentiment engine uses a first set of dictionaries for the first source of user generated communications, and a second set of character-term dictionaries for a second source of user generated communications, the first and second set of dictionaries being different.

19. The system of claim 18, wherein the first and second set of dictionaries each include an entity term dictionary for the respective first or second source of user generated communications.

20. The system of claim 18, wherein the first and second set of dictionaries each include a sentiment term dictionary for the respective first or second source of user generated communications.

21. The system of claim 18, wherein the first and second set of dictionaries each include an entity term dictionary, a sentiment term dictionary, an emphatic dictionary and a negation dictionary.

22. The system of claim 15, wherein the sentiment engine includes logic to analyze individual communications to link terms of sentiment with terms of commercial entities in order to determine the sentiment value for individual commercial entities.

23. The system of claim 15, wherein the commercial entity corresponds to one of a product, a product attribute or a brand.

24. The system of claim 15, wherein the sentiment engine determines the overall sentiment of each commercial entity by summing each sentiment value that is determined for that commercial entity.

25. The system of claim 15, wherein the sentiment engine determining the overall sentiment of a given product by determining a brand sentiment value for a brand related to the given product, and correlating the brand sentiment value to the given product.

26. The system of claim 15, wherein the sentiment engine determines the overall sentiment by executing a set of operations that include:
analyzing user generated communications provided through at least a first source to determine a plurality of commercially-relevant statements made by a plurality of persons that comprise the population, each of the plurality of commercially-relevant statements being determined to be relevant to one or more commercial entities of the plurality of commercial entities;
for at least some of the plurality of commercially-relevant statements, determining a sentiment value for each of the one or more corresponding commercial entities of the plurality of commercial entities;
for each of the plurality of commercial entities, determining the overall sentiment based on the sentiment value of each statement that is determined to be relevant to that commercial entity.

27. A sentiment engine, implemented by one or more processors that execute instructions, the sentiment engine comprising:
logic to analyze user generated communications provided through at least a first source to determine a plurality of commercially-relevant statements made by a plurality of persons that comprise the population, each of the plurality of commercially-relevant statements being determined to be relevant to one or more commercial entities of the plurality of commercial entities;
logic to determine, for at least some of the commercially-relevant statements, a sentiment value for each of the one or more corresponding commercial entities of the plurality of commercial entities;
logic to determine, for each of the plurality of commercial entities, the overall sentiment based on the sentiment value of each statement that is determined to be relevant to that commercial entity.
